(19) United States
(12) Patent Application Publication
(10) Pub. No.: US 2011/0144771 A1
(43) Pub. Date: Jun. 16, 2011

(54) SAFETY CONTROL APPARATUS

(75) Inventor: Kozo HIROMAE, Saitama-ken (JP)

(73) Assignee: KABUSHIKI KAISHA TOSHIBA, TOKYO (JP)

(21) Appl. No.: 12/833,295

(22) Filed: Jul. 9, 2010

(30) Foreign Application Priority Data
Dec. 11, 2009 (JP) 2009-282065

(51) Int. Cl. G05B 9/02

(52) U.S. Cl. 700/4

(57) ABSTRACT

A control program comprises a plurality of function division control programs and a plurality of verification instructions each described next to each function division control program. A first controller and a second controller execute the same function division control program in parallel, and respectively output an execution result and a verification indication signal when a verification instruction is detected after executing the function division control program. A third controller verifies whether two execution results match in response to two verification indication signals from the first controller and the second controller, and outputs a verification result to the first controller and the second controller. The first controller and the second controller respectively execute the function division control program again if the verification result represents unmatch, and respectively execute a next function division control program if the verification result represents match.

### CROSS-REFERENCE TO RELATED APPLICATION

This application is based upon and claims the benefit of priority from Japanese Patent Application No. 2009-282065, filed on Dec. 11, 2009; the entire contents of which are incorporated herein by reference.

### FIELD OF THE INVENTION

The present invention relates to a safety control apparatus having two controllers to execute the same control program in parallel, and a function to verify whether two execution results match.

### BACKGROUND OF THE INVENTION

In order to monitor a plant or safely control a field device, a safety control apparatus having redundant control channel is known. As to the safety control apparatus, two systems are well known. One is a duplex system which one of two control channels is set to stand-by status. The other is a verification dual system which has dual (redundant) control channels and a function to verify two outputs from the dual control channels.

In the safe control apparatus of the verification dual system, two controllers to independently execute the same control programs are equipped. In this case, two execution result data processed by the two controllers are verified. If the two execution result data match, the execution result data is output. This information control apparatus and method are, for example, disclosed in Japanese Patent No. 4102814 (Patent reference 1).

In the information control apparatus (the verification dual system) disclosed in Patent reference 1, if high reliability is required for output data, when a verification result of two execution result data processed by two controllers (channels) is unmatch, two controllers respectively execute the same control program again, and two execution result data by the two controllers are verified again. In this case, until the verification result is match, the execution result data is not output.

In general, the safety control apparatus (as the verification dual system) having dual control channels (to control a plant) is designed to complete processing of the control program within a control cycle (previously set).

However, as to the information control apparatus disclosed in Patent reference 1, when a verification result of two execution result data by two controllers (channels) is unmatch, a function to re-verify in short time is not disclosed. If the control program to be executed in the control cycle is processed from the beginning again, output of the execution result data at the control cycle is delayed. As a result, the control performance of this system falls.

### SUMMARY OF THE INVENTION

The present invention is directed to a safety control apparatus for minimizing a re-verification time when a verification result of two execution result data by two controllers is unmatch in the verification dual system.

According to an aspect of the present invention, there is provided a safety control apparatus comprising: a first controller configured to execute a control program having a plurality of function division control programs and a plurality of verification instructions each described next to each function division control program, and to output a first execution result of a function division control program and a first verification indication signal when a verification instruction is detected after executing the function division control program; a second controller configured to execute the control program in parallel with the first controller, and to output a second execution result of the function division control program and a second verification indication signal when the verification instruction is detected after executing the function division control program; and a third controller configured to verify whether the first execution result matches the second execution result when both the first verification indication signal and the second verification indication signal are received, and to output a verification result to the first controller and the second controller; wherein the first controller and the second controller respectively execute the function division control program again if the verification result represents unmatch, and respectively execute a next function division control program if the verification result represents match.

### BRIEF DESCRIPTION OF THE DRAWINGS

FIG. 1 is a block diagram of a safety control apparatus according to one embodiment.

FIG. 2 is a block diagram of a control program of the safe control apparatus in FIG. 1.

FIG. 3 is a schematic diagram of data component of a data memory in FIG. 1.

FIG. 4 is a schematic diagram of data component of a verification result data memory in FIG. 1.

FIGS. 5A and 5B are time charts to operate the control program in FIG. 2.

FIG. 6 is a flow chart of processing of the safety control apparatus in FIG. 1.

### DETAILED DESCRIPTION OF THE EMBODIMENTS

Hereinafter, embodiments of the present invention will be explained by referring to the drawings. The present invention is not limited to the following embodiments.

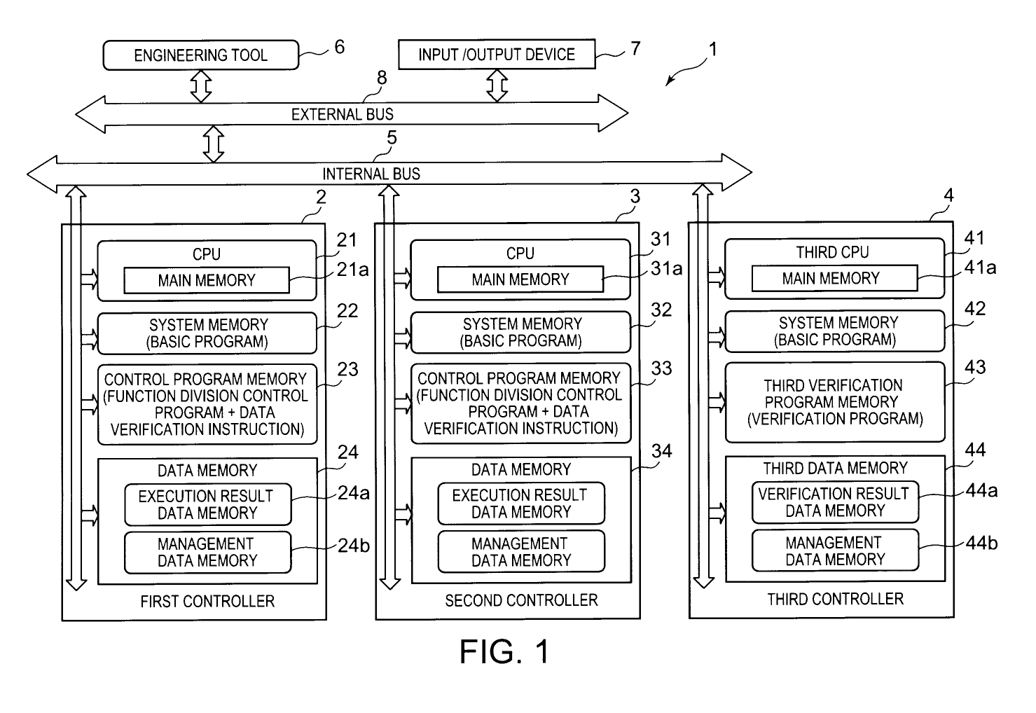

FIG. 1 is a block diagram of the safety control apparatus according to one embodiment. The safety control apparatus 1 includes a first controller 2 and a second controller 3 to execute the same control program in parallel, and a third controller 4 to decide match/unmatch of execution result data processed by two controllers 2 and 3.

The first controller 2 and the second controller 3 are connected to an internal bus 5, and the internal bus is further connected to an external bus 8. As to the external bus 8, an engineering tool to maintain such as install of the control program, and an input/output device 7 (as an interface for a sensor or a control object not shown in FIG.) to generate input/output signal of the first controller 2 and the second controller 3, are connected.

Next, component of each controller is explained. The first controller 2 and the second controller 3 have the same component. Accordingly, the first controller 2 is only explained, and explanation of the second controller is omitted.

The first controller 2 includes a CPU 21 (having a main memory 21a) to execute the control program, a system memory 22 to store a basic program of the CPU 21, a control program memory 23 to store the control program, and a data memory 24 to store execution result data processed by the CPU 21.

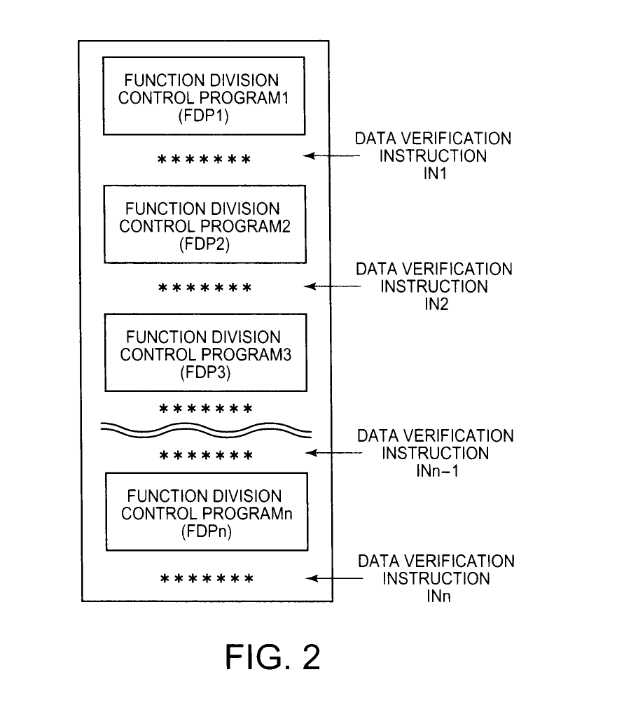

FIG. 2 shows component of the control program stored in the control program memory 23. As shown in FIG. 2, the control program comprises a plurality of control programs that divide functions (Hereinafter, each program is called “function division control program”) FDP1˜FDPn, and a plurality of data verification instructions IN1˜INn each of which is described between two function division control programs adjacent.

Unit of the function division control programs FDP1˜FDPn can be variously defined. Briefly, if each function division control program can process one control function, the program may have various sizes (large and small).

In order to set the unit, the engineering tool 6 can easily perform addition or deletion for the control program previously installed.

Furthermore, synchronization component between the first controller 2 and the second controller 3 is omitted because it is not a main subject of the present invention. As to this component, a program (software) to generate synchronization signal in a period sufficiently shorter than the control cycle between two controllers can be used. In general, a communication-protocol method using IC chip such as UART (Universal Asynchronous Receiver Transmitter) is used. However, the synchronization signal may be generated by hardware only.

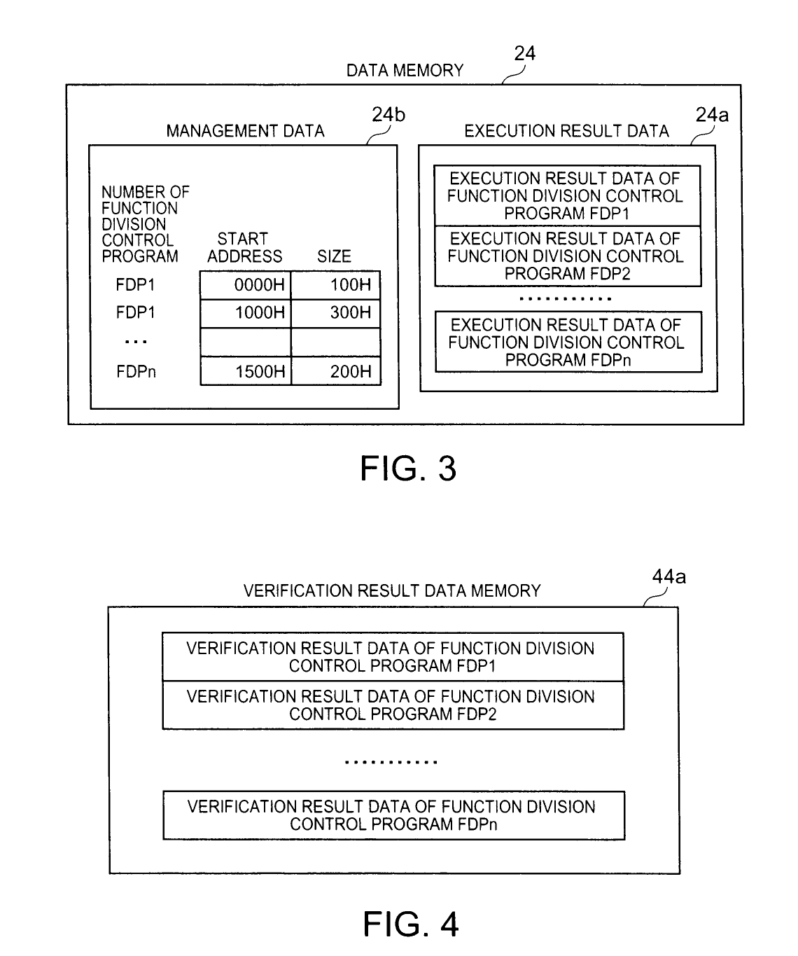

As shown in FIG. 3, the data memory 24 includes a memory region 24a to store execution result data (processed by the first controller 2) of each function division control program, and a memory region 24b to store management data of the execution result data.

For example, as to a function division control program FDP2, the management data having a start address “1000H” and a data size “300H”, and the execution result data, are respectively stored in different memory regions.

Next, the third controller 4 includes a third verification program memory 43 to store a verification program (to decide match/unmatch of two execution result data in response to a verification indication signal from the first controller 2 and the second controller 3), a third CPU 41 to execute the verification program, a system memory 42 to store a basic program of the third CPU 41, and a third data memory 44 to store verification result data of execution result data (processed by the first controller 2 and the second controller 3).

The third data memory 44 includes a memory region 44a to store verification result data and a memory region 44b to store management data (having a start address and a data size of the verification result data).

In the same way as the execution result data, as shown in FIG. 4, the verification result data is stored in correspondence with each number FDP1˜FDPn of function division control program.

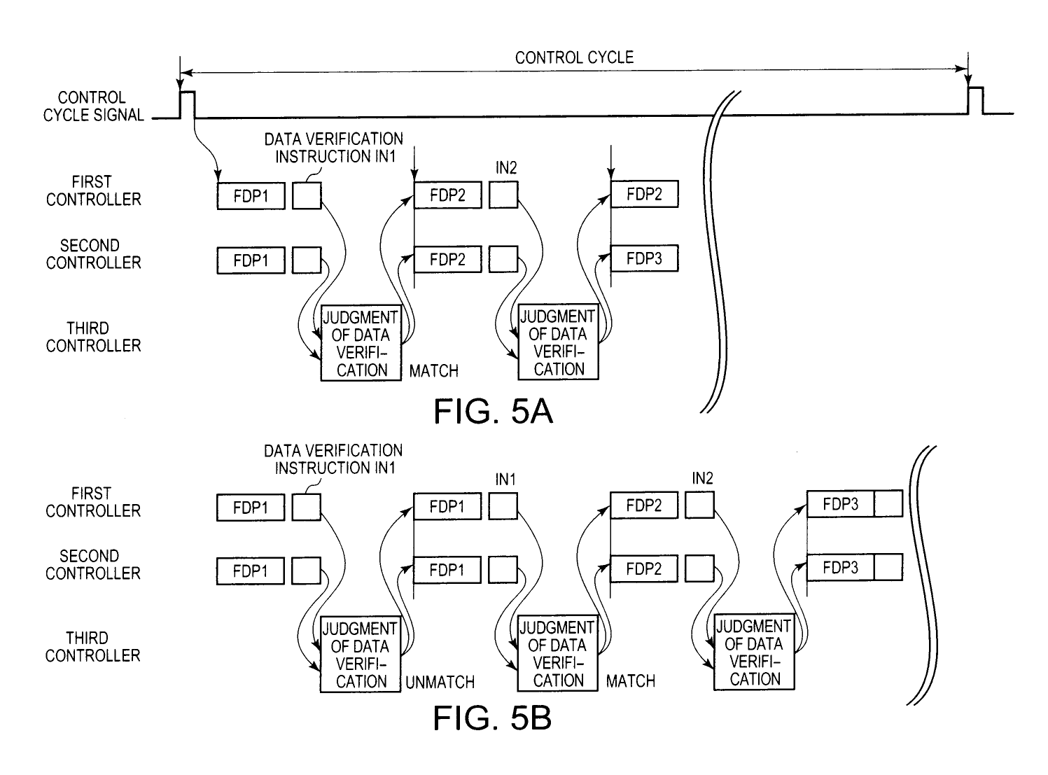

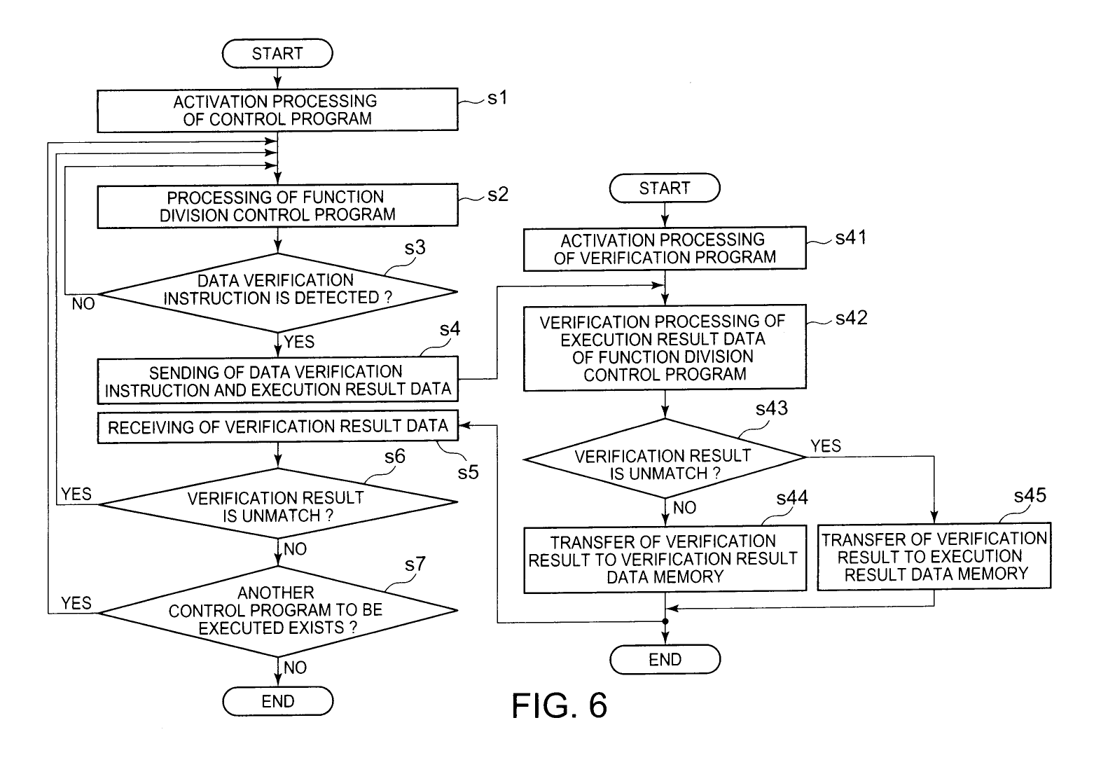

next, operation of the safety control apparatus is explained by referring to FIGS. 5A, 5B and 6. FIGS. 5A and 5B are time charts to explain a principle of the present invention and a summary of the operation of the safety control apparatus 1.

FIG. 5A is a time chart in case that verification result of execution result data (processed by the first controller 2 and the second controller 3) is match. FIG. 5B is a time chart in case that verification result of the execution result data is unmatch. As shown in FIGS. 5A and 5B, the first controller 2 and the second controller 3 respectively execute the control program in synchronization with a control cycle signal. First, they execute a division control program FDP1.

When the first controller 2 and the second controller 3 respectively detect a data verification instruction IN1 (inserted between two division control programs adjacent), they respectively send a verification indication signal with execution result data to the third controller 4.

The third controller 3 compares two execution result data (sent by the first controller 2 and the second controller 3), decides whether two execution results match, and sends verification result data (representing match/unmatch) to the first controller 2 and the second controller 3 via the internal bus 5.

In case of match, the first controller 2 and the second controller 3 respectively executes a division control program FDP2. In case of unmatch, the first controller 2 and the second controller 3 respectively executes the division control program FDP1 again.

Accordingly, as shown in FIG. 5B, in only case of unmatch, the division control program FDP1 is executed again, and execution result data are verified again. Briefly, different from the conventional art, all of the control program need not be executed again. As a result, the verification processing is completed in short time.

Furthermore, in order to synchronize two execution result data to be verified, even if sending time of execution result data by the first controller 2 is different from sending time of execution result data by the second controller 3, the third controller 4 cancels this timing difference by verifying two execution result data after receiving the two execution result data. In synchronization with verification result data sent by the third controller 4, the first controller 2 and the second controller 3 respectively start to execute next division control program at the same timing. As a result, the first controller 2 and the second controller 3 can be easily synchronized.

Next, processing operation of the safety control apparatus 1 is explained by referring to FIG. 6. FIG. 6 is a flow chart of main processing of a safety control program (comprising a control program and a verification program). First, the first controller 2 and the second controller 3 respectively activate the control program (s1).

Next, the first controller 2 and the second controller 3 respectively execute a first division control program FDP1 (s2), and detect a data verification instruction IN1 (s3). In this case, the first controller 2 and the second controller 3 respectively send execution result data (of the first division control program PDF1) and a verification indication signal to the third controller 4 via the internal bus 5 (s4). Whenever the first controller 2 and the second controller 3 respectively executes each division control program FDP2˜FDPn, they execute processing of steps s2˜s4. The execution result data (of each division control program) and the verification indication signal are sent to the third controller 4, and two execution result data (sent by the first controller 2 and the second controller 3) are verified.

Next, operation of the third controller 4 is explained. First, the third controller 4 activates a verification program (s41). After activation processing of the verification program is completed, the third controller 4 waits for receiving the verification indication signal from the first controller 2 and the second controller 3.

When the third controller 4 receives the verification indication signal with execution result data from the first controller 2 and the second controller 3 respectively, the third controller 4 executes the verification program (s42), and sends a verification result (whether two execution result data match) to the first controller 2 and the second controller 3 via the internal bus 5 (s43, s44, s45).

When the first controller 2 and the second controller 3 respectively receive the verification result “unmatch” (s5, s6), the first controller 2 and the second controller 3 respectively execute the same division control program again (s2, s3, s4). When the first controller 2 and the second controller 3 respectively receive the verification result “match” (s5, s7), the first controller 2 and the second controller 3 respectively execute a next division control program.

As mentioned-above, in the present embodiment, the third processor 4 verifies two execution result data of each function division control program in synchronization with the verification indication signal and the verification program. Accordingly, judgment of verification and re-processing (in case of unmatch) of the division control program can be executed in short time.

In general, the third controller 4 sends verification result data to the input/output device 7 via the internal bus 4 and the external bus 7. The verification result data from the input/output device 7 is selected by selection logic (previously set) of the safety control apparatus 1.

Moreover, the present invention is not limited to above-mentioned embodiment. The control program is divided into a plurality of function division control programs. The verification program is activated in response to the verification indication signal and execution result data (of each function division control program). Based on the verification result, the next function division control program is executed. Briefly, any apparatus which have above function can be applied. Furthermore, unit of the function division control program can be composed as various functions.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel systems described herein may be embodied in a variety of other forms; furthermore, various omissions, substitutions and changes in the form of the systems described herein may be made without departing from the spirit of the inventions. The accompanying claims and their equivalents are intended to cover such forms or modifications as would fall within the scope and spirit of the inventions.

What is claimed is:

1. A safety control apparatus comprising:
a first controller configured to execute a control program having a plurality of function division control programs and a plurality of verification instructions each described next to each function division control program, and to output a first execution result of a function division control program and a first verification indication signal when a verification instruction is detected after executing the function division control program;
a second controller configured to execute the control program in parallel with the first controller, and to output a second execution result of the function division control program and a second verification indication signal when the verification instruction is detected after executing the function division control program; and
a third controller configured to verify whether the first execution result matches the second execution result when both the first verification indication signal and the second verification indication signal are received, and to output a verification result to the first controller and the second controller;
wherein the first controller and the second controller respectively execute the function division control program again if the verification result represents unmatch, and respectively execute a next function division control program if the verification result represents match.

2. A computer readable medium storing program codes for causing a computer to operate three controllers, the program codes comprising:
a first program code for a first controller to execute a control program having a plurality of function division control programs and a plurality of verification instructions each described next to each function division control program;
a second program code for the first controller to output a first execution result of a function division control program and a first verification indication signal when a verification instruction is detected after executing the function division control program;
a third program code for a second controller to execute the control program in parallel with the first program code;
a fourth program code for the second controller to output a second execution result of the function division control program and a second verification indication signal when the verification instruction is detected after executing the function division control program;
a fifth program code for a third controller to verify whether the first execution result matches the second execution result in response to both the first verification indication signal and the second verification indication signal;
a sixth program code for the third controller to output a verification result;
a seventh program code for the first controller and the second controller to respectively execute the function division control program again if the verification result represents unmatch; and
an eighth program code for the first controller and the second controller to respectively execute a next function division control program if the verification result represents match.
